(19) United States
(12) Patent Application Publication
(10) Pub. No.: US 2016/0027120 A1
(43) Pub. Date: Jan. 28, 2016

(54) SYSTEMS AND METHODS FOR REPORTING AND REPLACEMENT OF LOST/STOLEN ITEMS

(71) Applicant: Kenneth Smith, Cambridge, MA (US)

(72) Inventor: Kenneth Smith, Cambridge, MA (US)

(21) Appl. No.: 14/674,872

(22) Filed: Mar. 31, 2015

Related U.S. Application Data
(60) Provisional application No. 62/029,830, filed on Jul. 28, 2014.

(51) Int. Cl. G06Q 40/08; G06Q 30/02

(52) U.S. Cl. CPC G06Q 40/08; G06Q 30/0239

(57) ABSTRACT

A system and method of facilitating replacement of a stolen item, including receiving a first user profile; receiving a plurality of item descriptions associated with the first user profile; storing the received item descriptions and the associated first user profile in a first plurality of computer readable data structures; receiving a selection constituting an item description selected from the plurality of item descriptions stored in the first plurality of computer-readable data structures; receiving an item loss description describing loss of the selected item; storing an item loss report in a second plurality of computer-readable data structures; obtaining a third plurality of computer-readable data structures including a. discount offer authorizing purchase of the selected item from a vendor at a discount from a retail purchase price; comparing the selected item description from the second plurality of data structures and the item discount offer from the third plurality of data structures; identifying an item discount offer corresponding to the selected item description; and generating a notification including the identified discount offer.

### CROSS-REFERENCE TO RELATED APPLICATIONS

This application claims the benefit of and priority to U.S. Provisional Application No. 62/029,830, filed on Jul. 28, 2014 and entitled SYSTEMS AND METHODS FOR REPORTING AND REPLACEMENT OF LOST/STOLEN ITEMS. The entire teachings of the above application are incorporated herein by reference for all purposes.

### BACKGROUND

It is estimated by law enforcement that approximately 7% of personal property stolen in the United States is recovered or returned to its rightful owner. Furthermore, while approximately 8,500,000 items are reported annually, it is estimated that this number represents only about 40% of all actual loss incidents. This means that in an estimated 7,905,000 cases, stolen property is never recovered, costing victims nearly 14 billion dollars.

According to more than 30 law enforcement agencies spanning local, state, and federal jurisdictions, two main reasons are ascribed to this observation. First, incident reports are typically filed hours or days after an incident takes places. Second, there is a lack of detailed product information provided by the victim to track stolen goods online or pawn/used good dealers. Thirdly, reports are generally filed in paper format and, even where filed electronically, sharing amongst law enforcement is poor and highly fragmented.

### SUMMARY

In an embodiment, a method of facilitating replacement of a stolen item is provided. The method includes: receiving a first user profile; receiving a plurality of item descriptions associated with the first user profile; storing the received item descriptions and the associated first user profile in a first plurality of computer-readable data structures; receiving a selection constituting an item description selected from the plurality of item descriptions stored in the first plurality of computer-readable data structures; receiving an item loss description describing loss of the selected item; storing an item loss report in a second plurality of computer-readable data structures, the item loss report including the first user profile, the selected item descriptions, and the loss incident description; obtaining a third plurality of computer-readable data structures including a discount offer authorizing purchase of the selected item from a vendor at a discount from a retail purchase price; comparing the selected item description from the second plurality of data structures and the item discount offer from the third plurality of data structures; identifying an item discount offer corresponding to the selected item description; and generating a notification including the identified discount offer; where the method is performed by one or more processors executing computer readable code embodied in non-transitory computer usable media.

Embodiments of the method may include one or more of the following, in any combination.

In an embodiment, the method further includes transmitting the notification for receipt by a computing device of the user associated with the first user profile.

In an embodiment of the method, the item description includes one or more of: a text description, plurality of photographs, a purchase receipt, and an item serial number.

In an embodiment of the method, the loss report includes one or more of a loss time, loss location, perpetrator description, weapon description, and estimated item cost.

In an embodiment, the method further includes: receiving a law enforcement profile, different than the first user profile; transmitting the item loss report to a second user, different than the first user, associated with the law enforcement profile; and receiving a transmission including a law enforcement validation of the item loss report.

In an embodiment of the method, the law enforcement profile includes a credential uniquely identifying a law enforcement officer, a law enforcement agency, or a designate thereof.

In an embodiment, the method further includes: receiving an insurance agent profile, different than the first user profile and the law enforcement profile; receiving a request for at least a portion of the validated item loss report; and transmitting the requested, validated item loss report to a third user, different than the first and second users, associated with the insurance agent profile.

In an embodiment, the method further includes receiving a transmission indicating redemption of the identified discount offer included in the notification.

Embodiments of the disclosure further provide a system for facilitating replacement of a stolen item. The system includes: a data storage device; and one or more processors in communication with the data storage device. The one or more processors are operative to: receive a first user profile; receive a plurality of item descriptions associated with the first user profile; store the received item descriptions and the associated first user profile in a first plurality of computer-readable data structures; receive a selection constituting an item description selected from the plurality of item descriptions stored in the first plurality of computer-readable data structures; receive an item loss description describing loss of the selected item; store an item loss report in a second plurality of computer-readable data structures, the item loss report including the first user profile, the selected item descriptions, and the loss incident description; obtain a third plurality of computer-readable data structures including a discount offer authorizing purchase of a item from a vendor at a discount from a retail purchase price; compare the selected item description from the second plurality of data structures and the item discount offer from the third plurality of data structures; identify an item discount offer corresponding to the selected item description; and generate a notification including the identified discount offer.

Embodiments of the system may include one or more of the following, in any combination.

In an embodiment of the system, the one or more processors are further adapted to transmit the notification for receipt by a computing device of the user associated with the first user profile.

In an embodiment of the system, the one or more processors are further adapted to: generate a first plurality of user interfaces for receiving the first user profile; and generate a second plurality of user interfaces for receiving the item description selection and the item loss description.

In an embodiment of the system, the item description includes one or more of: a text description, plurality of photographs, a purchase receipt, and an item serial number.

In an embodiment of the system, the loss report includes one or more of a loss time, loss location, perpetrator description, weapon description, and estimated item cost.

In an embodiment of the system, the one or more processors are further adapted to: receive a law enforcement profile, different than the first user profile; transmit the item loss report to a second user, different than the first user, associated with the law enforcement profile; and receive a transmission including a validation of the requested item loss report.

In an embodiment of the system, the law enforcement profile includes a credential uniquely identifying a law enforcement officer, a law enforcement agency, or a designate thereof.

In an embodiment of the system, the one or more processors are further adapted to: receive an insurance agent profile, different than the first user profile and the law enforcement profile; receive a request for at least a portion of the validated item loss report; and transmit the requested, validated item loss report to a third user, different than the first and second users, associated with the insurance agent profile.

In an embodiment of the system, the one or more processors are further adapted receive a transmission indicating redemption of the identified discount offer included in the notification.

In an embodiment of the system, the one or more processors are further adapted to: generate a third plurality of user interfaces for receiving the law enforcement profile and item loss report request; and generate a fourth plurality of user interfaces for receiving the insurance agent profile and requesting the validated item loss report.

In an embodiment of the system, the one or more processors are further adapted to receive a transmission indicating redemption of the identified discount offer included in the notification.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a schematic illustration of a computing environment including an embodiment of a property management and replacement system of the present disclosure;

FIG. 2 is a schematic flow diagram illustrating an overview of embodiments of operations that may he performed by a user of the system of FIG. 1;

FIG. 3 is a schematic user interface generated by embodiments of the system of FIG. 1 for use by a user to input user profile information;

FIGS. 4A-4D are schematic user interfaces generated by embodiments of the system of FIG. 1 for use by a user to input a plurality of item descriptions associated with the user profile;

FIG. 5 is a schematic flow diagram illustrating embodiments of a process for generating an incident report regarding a lost or stolen item;

FIGS. 6A-6C are schematic user interfaces generated by embodiments of the system for gathering information from a user sufficient to generate the incident report according to embodiments of the process of FIG. 5;

FIG. 7 is a schematic flow diagram illustrating embodiments of a process for accessing and verifying incident reports generated according embodiments of the process of FIG. 5;

FIGS. 8A-8B are schematic user interfaces generated by embodiments of the system for accessing and verifying incident reports generated according embodiments of the process of FIG. 7;

FIG. 9 is a schematic flow diagram illustrating embodiments of a process for providing a user with a discount offer for replacement of an item reported lost or stolen in an incident report generated according to embodiments of the process of FIG. 7; and

FIG. 10 is a schematic user interface generated by embodiments of the system allowing notification that an item reported lost or stolen has been found by a member of the public.

### DETAILED DESCRIPTION

Embodiments of the disclosure are directed to reducing the financial impact of lost or stolen goods on victims by improving the timeliness and accuracy of reporting lost or stolen goods and facilitating a discount offer for replacement purpose.

For example, a property management and reporting system is provided that allows a user to prepare an electronic catalog of personal property. In the event that an item is lost or stolen, the system user may login to the system to select the lost or stolen item from the pre-populated list of items listed in the user's profile. The user may further provide the system with information regarding the circumstances surrounding the item theft (also referred to herein as the incident). After identifying the lost or stolen property and describing the incident, the user may confirm and submit this information to the system for generation of an incident report. The incident report may be stored by the system for future use, transmitted to a law enforcement computing system, and/or accessed from the system by designated law enforcement personnel. Subsequently, law enforcement personnel may review and verify submitted incident reports. In this manner, the system may greatly improve the speed and ease of with which a victim may submit an incident report regarding lost or stolen property, as well as improve the efficiency with Which law enforcement personnel may respond. Furthermore, the pre-populated item descriptions provided to the system may be of significantly greater detail than those provided from memory by a victim.

In further embodiments, the system may facilitate replacement of a lost or stolen item covered by insurance. For example, in one embodiment, an incident report verified by law enforcement personnel may be stored by the system, transmitted to an insurance broker computing system, and/or accessed from the system by designated insurance agents, insurance agencies, and delegates thereof. In this manner, incident reports verified by law enforcement, often required to submit an insurance claim, may be obtained relatively quickly and efficiently by insurance company personnel with a minimum of time and effort on the part of the victim.

In another embodiment, the system may facilitate replacement of a lost or stolen item not covered by insurance. For example, the system may obtain a plurality of discount offers authorizing purchase of respective items at a discount from a retail purchase price. The system may further compare the plurality of discount offers to one or more items identified as stolen in the generated incident report to identify a match. Upon identifying a match, a notification is Generated to inform the user of the discount offer. In this manner, the financial cost to the victim for replacement of the stolen item(s) is reduced. The discount offer may be further provided rapidly after generation of the incident report (e.g., within a matter of minutes, hours, or a few days), allowing the victim to quickly replace the stolen item(s) at a discount.

In a further embodiment, the system may facilitate finding of a lost or stolen item. For example, the system may allow a user to post information regarding a lost or stolen item to a publically facing portal. Members of the public may view listings of reported lost or stolen items on the public portal and respond if the item is found, Beneficially, this functionality may leverage public populations to facilitate retrieval of items.

To the inventor's knowledge, embodiments of the disclosed systems and methods provide the first single, standard electronic form for filing reports of lost and/or stolen goods anytime, anywhere, from any device in real time. At present, there does not exist an electronic portal that catalogs items owned by a user, allows a user to generate an electronic lost/stolen goods report, and further allows police and other law enforcement personnel nationwide to review and validate such reports.

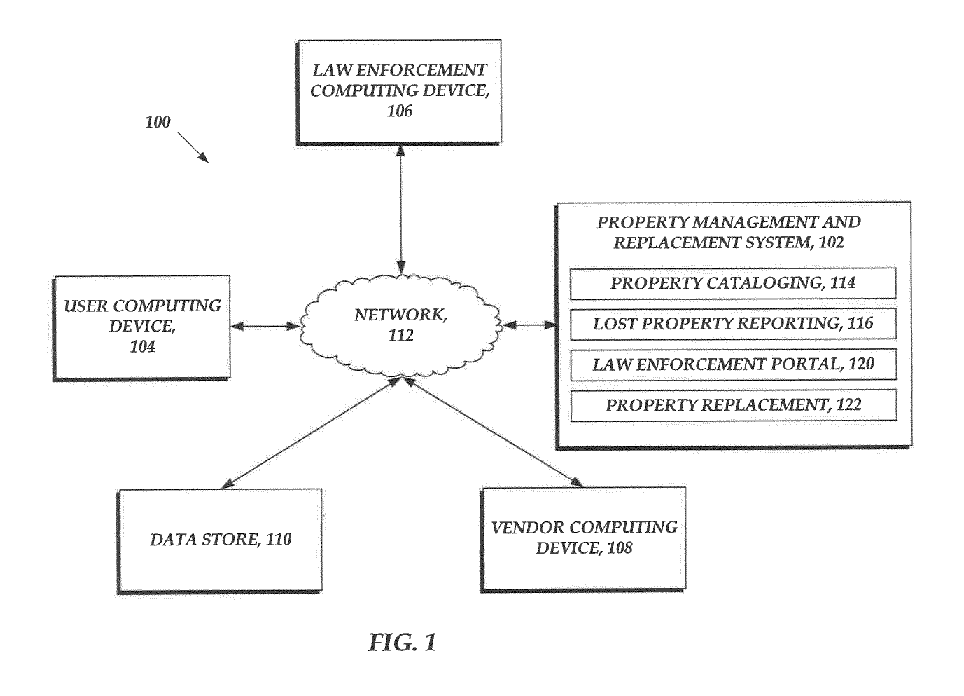

The discussion will now turn to FIG. 1, illustrating a computing environment 100 including embodiments a property management and replacement system 102 of the present disclosure. The environment 100 may further include a user computing device 104, a law enforcement computing device 106, a vendor computing device 108, and a data store 110 in communication via a network 112. In the discussion herein, reference may be made to lost items. It may be understood that lost items may refer to items that are misplaced, such that a user is unable to find them, damaged or broken such that a user is unable to use the item, or items that are stolen from the user's possession (e.g., the from the user's person, from a space owned, rented, or otherwise controlled by a user, etc.).

In an illustrative embodiment, the computing devices 104, 106, 108 may be one or more computing devices employed to input and/or receive information from the system 102. Examples of computing devices may include, but are not limited to, personal computing devices, laptop computing devices, hand-held computing devices, terminal computing devices, mobile devices, wireless devices, various electronic devices and appliances and the like. In an illustrative embodiment, the user computing device 104 may be one or more computing devices employed by a user to input and/or receive information from the system 102. Likewise, the law enforcement computing device and vendor computing device may be one or more computing devices employed by law enforcement personnel and vendors (e.g., insurance brokers, wholesale/retail merchants) to input and/or receive information from the system 102.

The data store 110 is any storage device capable of maintaining data in storage. For clarity, a single data storage device 110 is illustrated in FIG. 1. However, it may be understood that the data store 110 may represent a plurality of data storage devices. Examples of the data storage device 110 may include, but are not limited to, logical and physical data storage devices, static and dynamic memories, magnetic storage devices, solid state memory devices, and the like. The data store 110 may communicate with the system 102 locally, remotely, and combinations thereof.

The network 112 is a communications network capable of exchanging data between the various components of environment 100. Examples may include, but are not limited to, wide area networks and local area networks connecting the components of environment 100 by fixed wire, wireless, and combinations thereof.

The system 102 may include a property cataloging component 114, a stolen property reporting component 116, a law enforcement portal component 120, and property replacement component 122. As discussed in greater detail below, each component may generate a plurality of user interfaces designed to facilitate input, receipt, and/or display of information by the system 102. For example, the property cataloging component 114 may be configured to generate a plurality of user interfaces facilitating input and display of item descriptions associated with the user profile by a user employing his or her user computing device.

The stolen property reporting component 116 may be configured to generate a plurality of user interfaces facilitating generation of an incident report. Information received by the plurality of user interfaces, as well as the generated incident report may be transmitted to the data storage device 110 for storage.

For example, the component 116 may be configured to allow selection of one or more previously input item. descriptions, further input of loss incident information, verification/editing of profile information, and submission of each to the system 102 by a user employing his or her user computing device.

The law enforcement portal component 120 may be configured to generate a plurality of user interfaces facilitating transmission and verification of one or more incident reports to law enforcement personnel employing law enforcement computing device 106. The incident reports may be obtained from the system 102 directly or from another computing system maintained and/or authorized delegate/contractor of law enforcement.

The property replacement 122 component may be configured to generate a plurality of user interfaces facilitating transmission of one or more verified incident reports to insurance personnel employing vendor computing device 108. The incident reports may be obtained from the system 102 directly or from another computing system maintained and/or an authorized delegate/contractor of the insurance company.

The property replacement component 122 may be configured to obtain the discount offers and identify one or more offers matching a stolen item identified in the incident report. Upon identification of the matching offer(s), the component 122 may generate and transmit a notification of the matching discount offer for receipt by the user at their user computing device 104.

One skilled in the relevant art will appreciate that components of the system 102 and configurations provided in FIG. 1 are illustrative in nature. Accordingly, additional or alternative components and/or configurations may be utilized, The components of the system 102 may be further implemented in one or more of hardware and software.

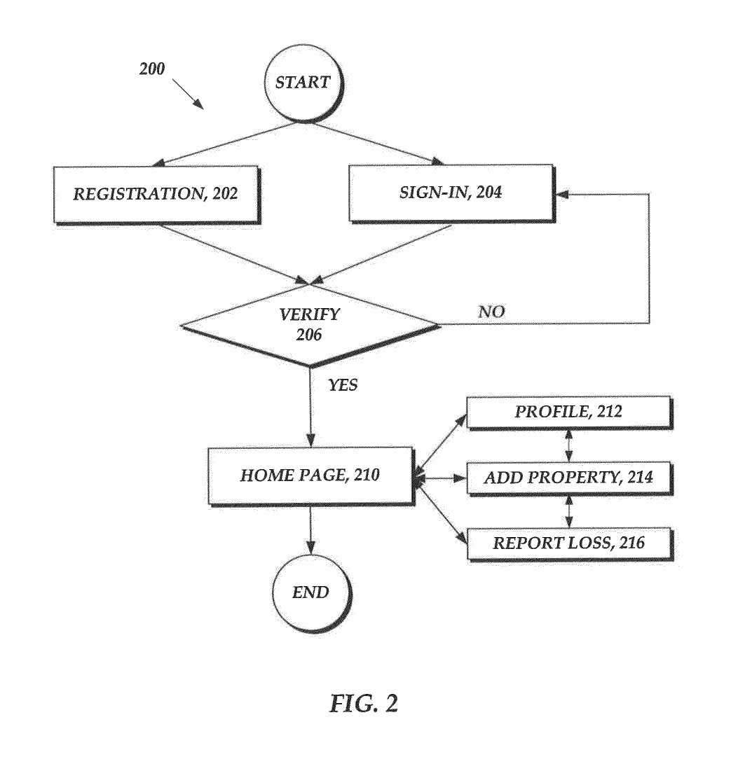

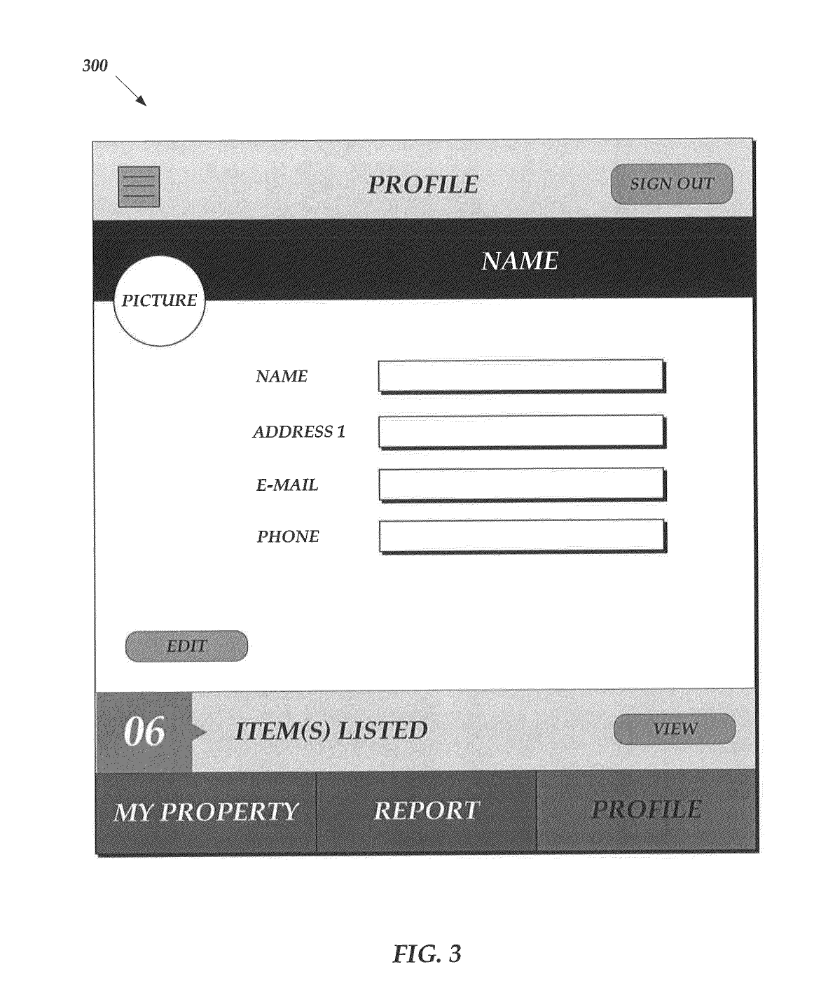

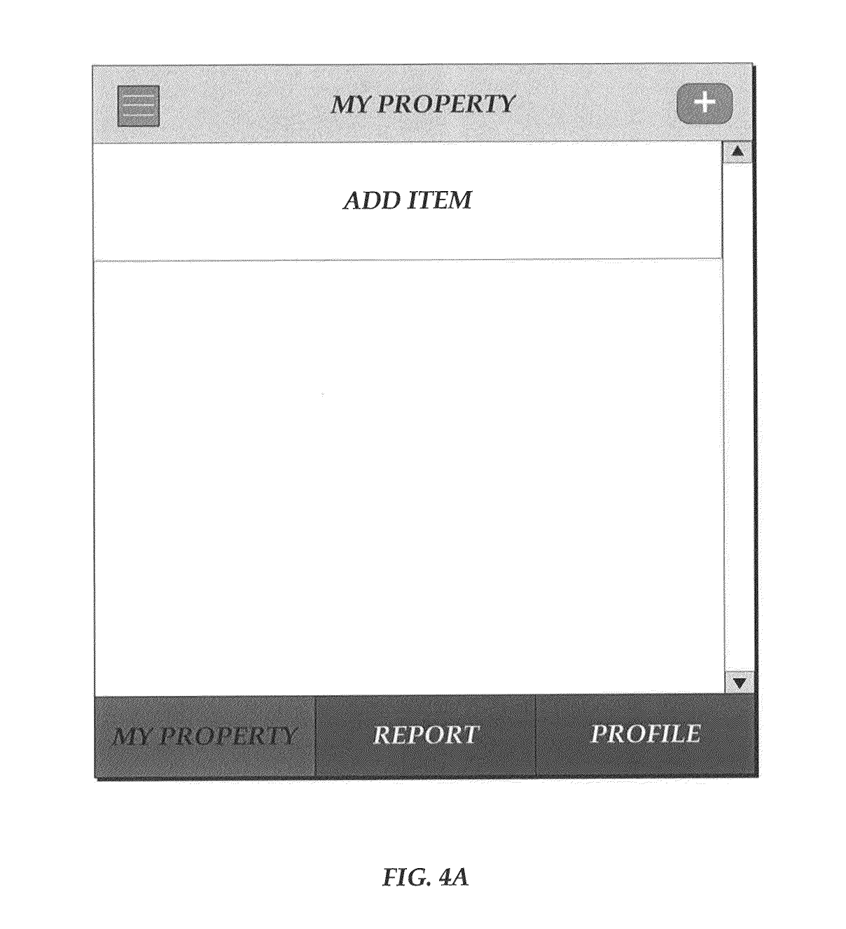

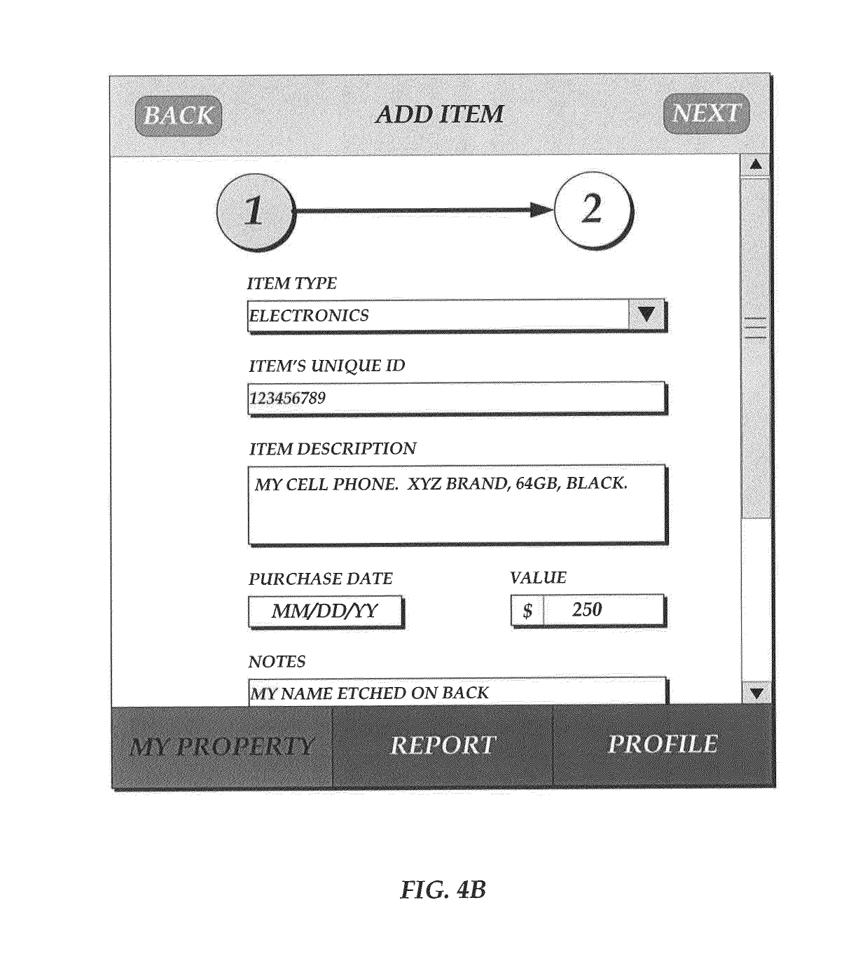

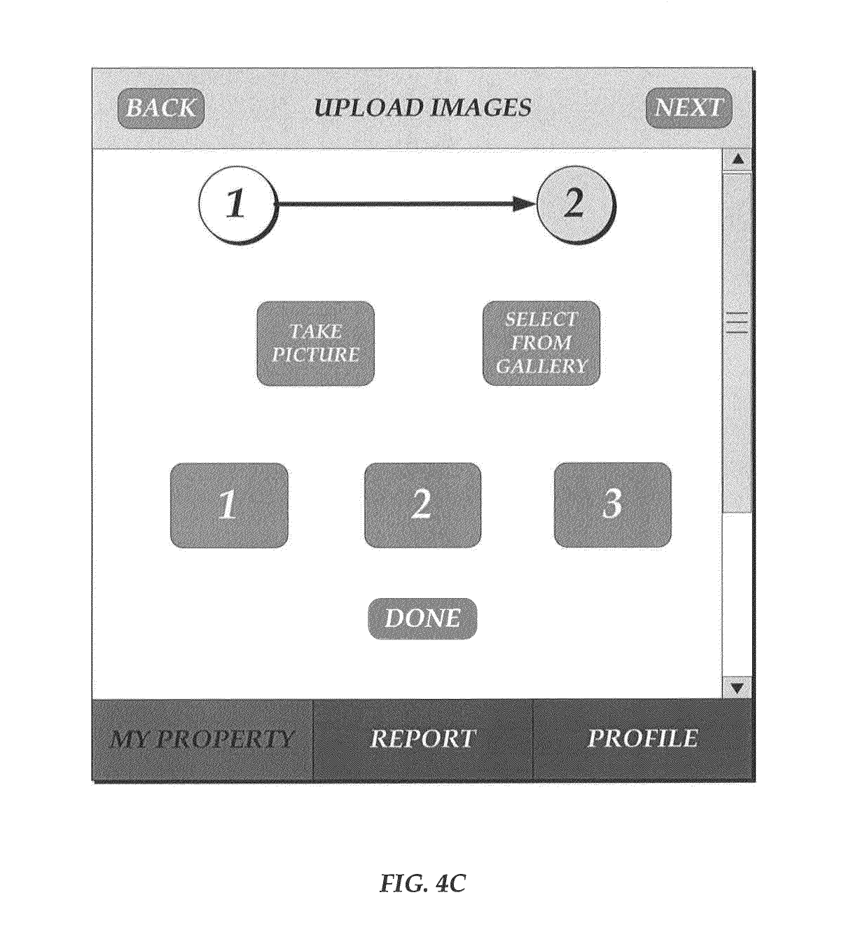

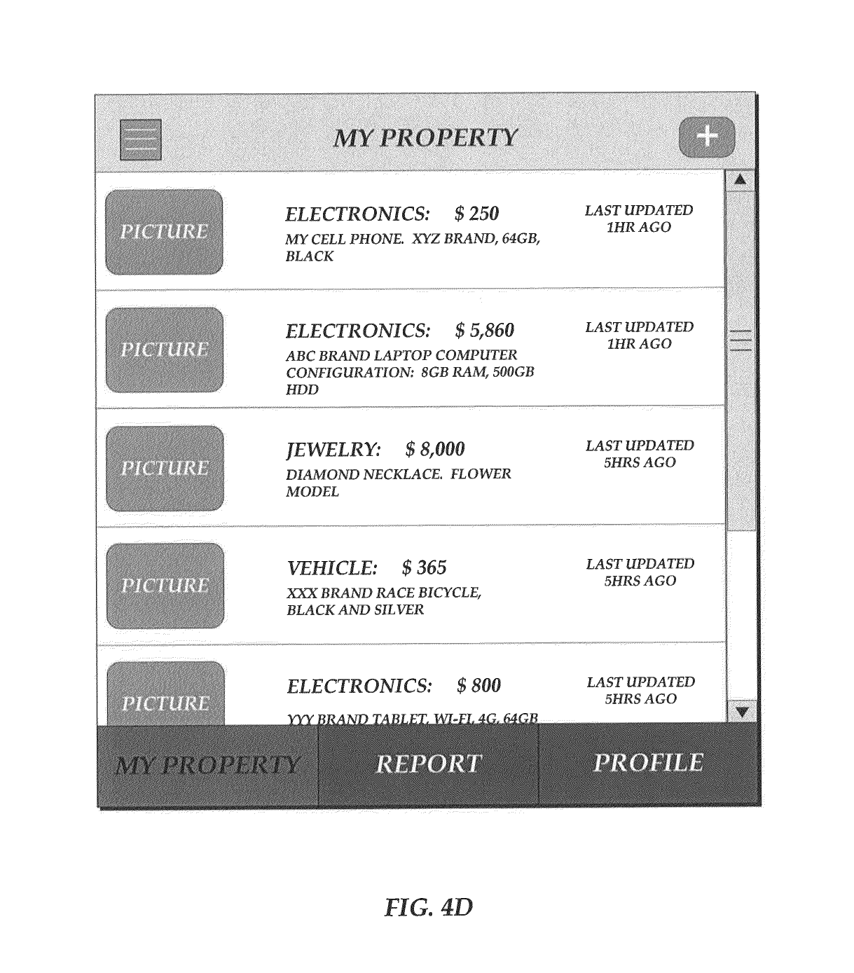

The discussion will now turn to the embodiments of FIGS. 2, 3, and 4A-4D. FIG. 2 illustrates a flow diagram including embodiments of a process 200 performed by the system 102 for generating an incident report. FIGS. 3 and 4A-4D illustrate embodiments of user interfaces corresponding to the process 200 of FIG. 2.

In operations 202, 204, 206, a user employing his or her user computing device 104 gains access to the system 102. For example, in operation 202, a first time user may be registered with the system 102, providing the system 102 with selected identifying sign-in information (e.g., a username and password). Alternatively, in operation 204, users who have already registered with the system 102 may provide their sign-in information.

Upon verification of the provided sign-in information, the user may be directed to a home page, where further account maintenance and property management and replacement operations may be selected in operations 212, 214, 216. For example in operation 212, a user may provide detailed user profile information, as known in the art. With further reference to FIG. 3, examples of the user profile information may include, but are not limited to, a user's name, address, telephony information (phone number, fax number, etc.), e-mail address, picture, and the like.

In operation 214, with further reference to embodiments of FIGS. 4A-4D, the system may generate a plurality of user interfaces allowing a user to input item, description information regarding one or more items owned by the user using his or her user computing device 104 (e.g., a smart phone, a desktop computing device, a laptop computing device, etc.) prior to a loss/theft incident. As illustrated in FIG. 4A, a list of items owned by the user (“My Property”) may begin blank. In FIGS. 4B-4C, the user may provide item description information including, but not limited to, an item type or category (e.g., electronics), a unique identifier, such as a serial number, a detailed description of the item, a purchase date, an item value, electronic copies of a purchase receipt (not shown), additional notes, one or more electronic photographs, and the like. After a description has been provided for an item, any of the item description received by the system 102 may be stored and subsequently viewed and/or further editing (FIG. 4D). Additional items may be further added in the same manner, as necessary.

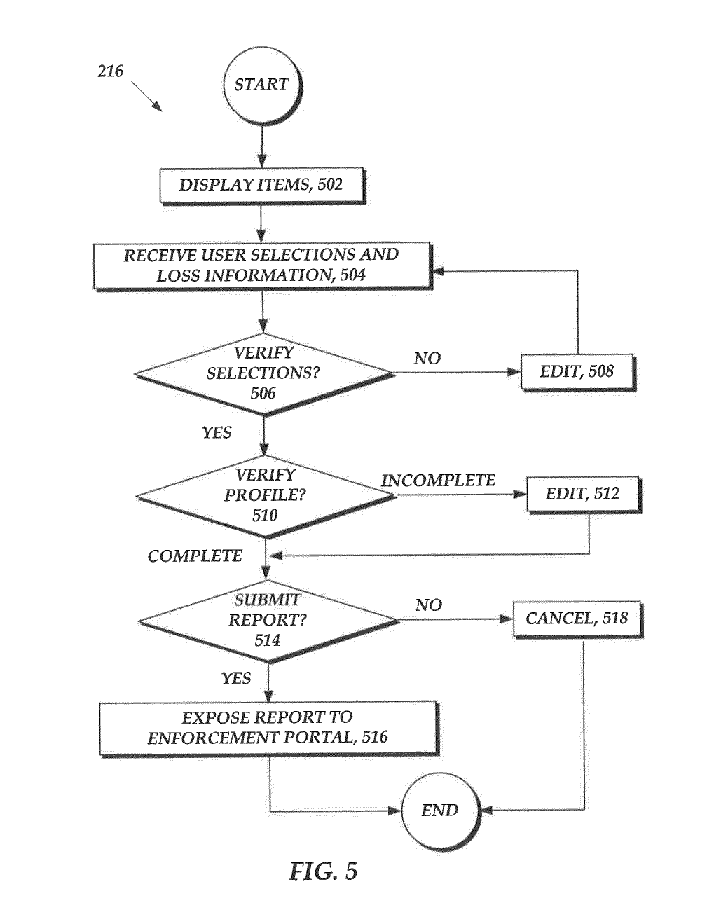

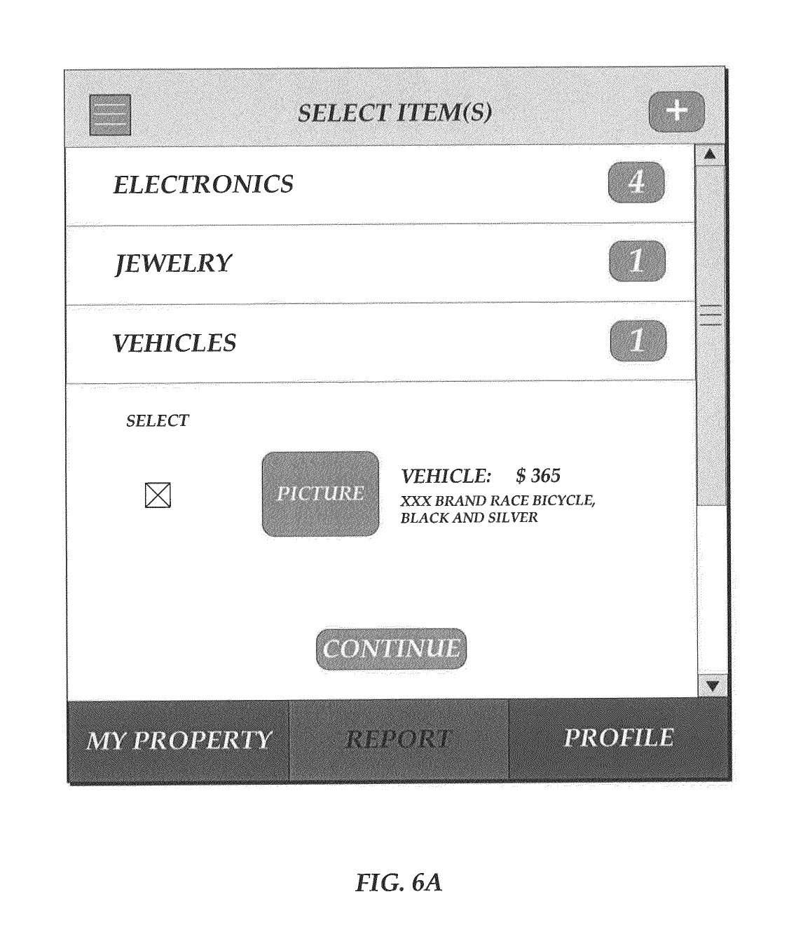

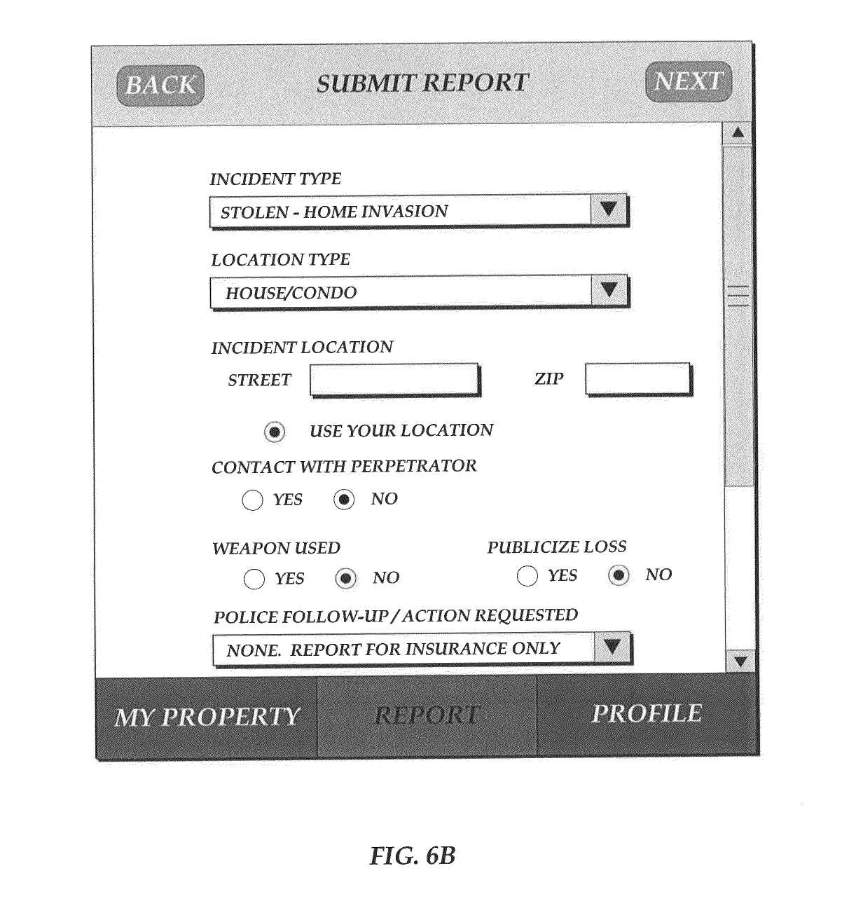

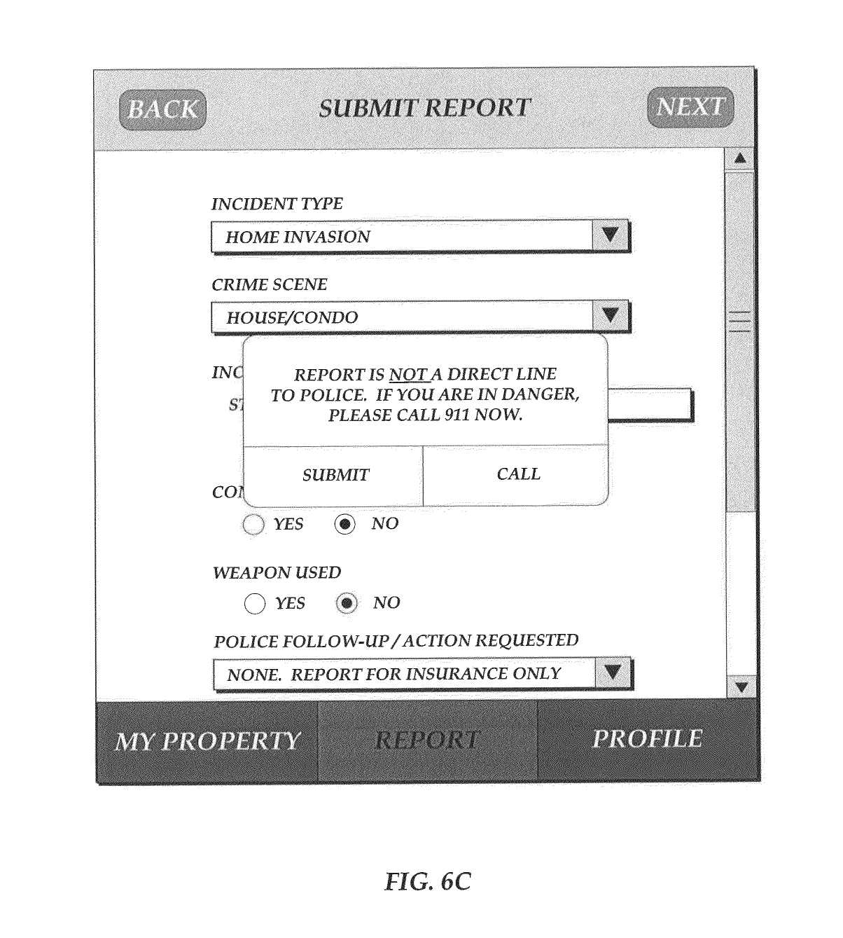

The discussion will now turn to the embodiments of FIGS. 5 and 6A-6C. FIG. 5 illustrates a flow diagram including process 216 performed by the system 102 for generating an incident report. FIGS. 3 and 4A-4D illustrate embodiments of user interfaces corresponding to the process 216 of FIG. 5.

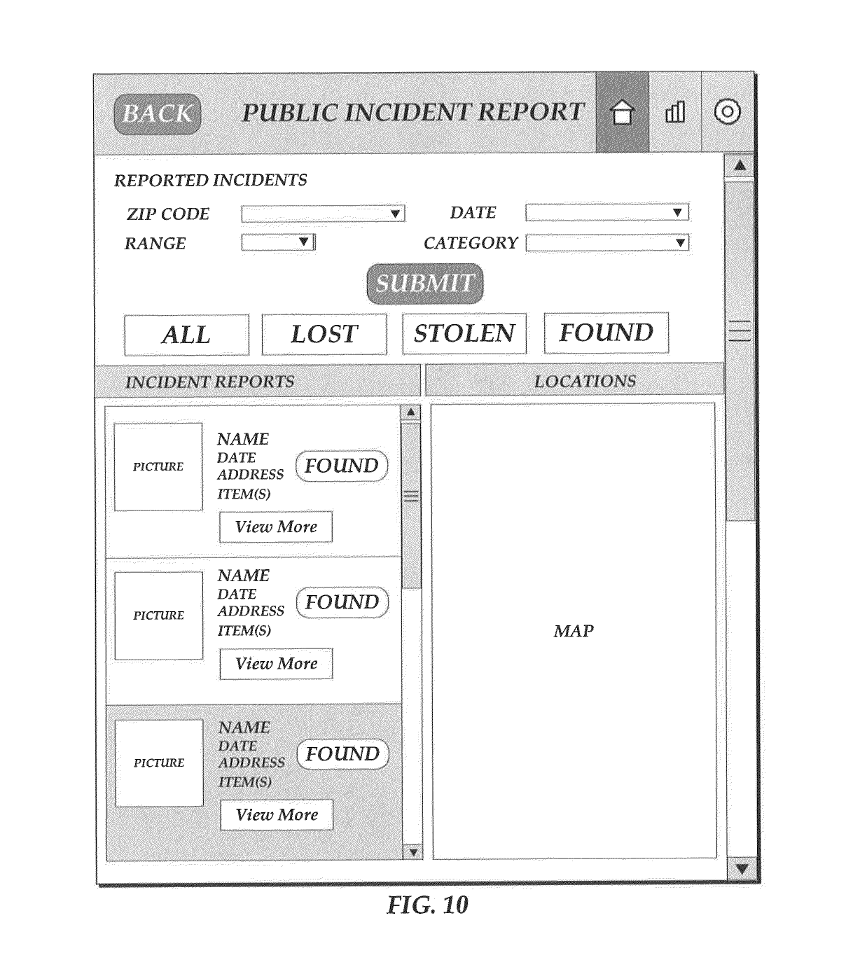

In operation 502, the user's item descriptions are displayed, as illustrated in FIG. 6A. In operation 504, user selections of one or more items descriptions are received via embodiments of the user interface of FIG. 6A, the selections indicating items that have been lost/stolen. The user may further employ embodiments of the user interface 6B to complete the incident report by adding additional incident information. Examples of the incident information may include, but are not limited to, an incident type (e.g., lost, stolen—home invasion, stolen—mugging, etc.), a loss location type (e.g., house/condo, street, business, etc.), an incident location address and/or picture, an indication whether contact was made with a perpetrator, whether a weapon was involved in the incident, an optional law enforcement follow-up request, a victim statement, etc. In further embodiments, discussed in greater detail below in regards to FIG. 10, a user may choose to make a portion of their incident report public.

After the incident information is supplied, in operation 504, the process 216 moves to operation 506, where the user is prompted to verify or change their selected items. If the user elects to change their selected items, the process 216 returns to operation 504. If the user verifies their selected items, the process 216 moves to operation 510, where the user is prompted to verify their profile. If the user elects to change their user profile, or the system 102 identifies that required information (e.g., the user's name, contact information, etc.) is missing, the process 216 moves to operation 512, allowing edits to be made to the user profile. If the user's profile is verified, the process 216 moves to operation 514, where the user is prompted to confirm submission of the incident information, item selections, and their user profile (see, e.g., FIG. 6C). If the user elects to cancel their incident report prior to submission, the process 216 moves to operation 518, which ends the process 216. Alternatively, if the user confirms their incident report submission, user interface of FIG. 6C further provides a notification (e.g., pop-up window) that submission of the report is taken as authorization for use of the incident report by law enforcement personnel. Subsequently, the process 216 moves to operation 516.

In operation 516, the submitted incident report is exposed to the enforcement portal 520. In an embodiment, such exposure may include, but is not limited to, hosting the report for access by law enforcement personnel using his or her law enforcement computing device 106 via the network 112. Alternatively, an electronic copy of the incident report may be transmitted to the law enforcement computing device 106 for storage and further access, as discussed below.

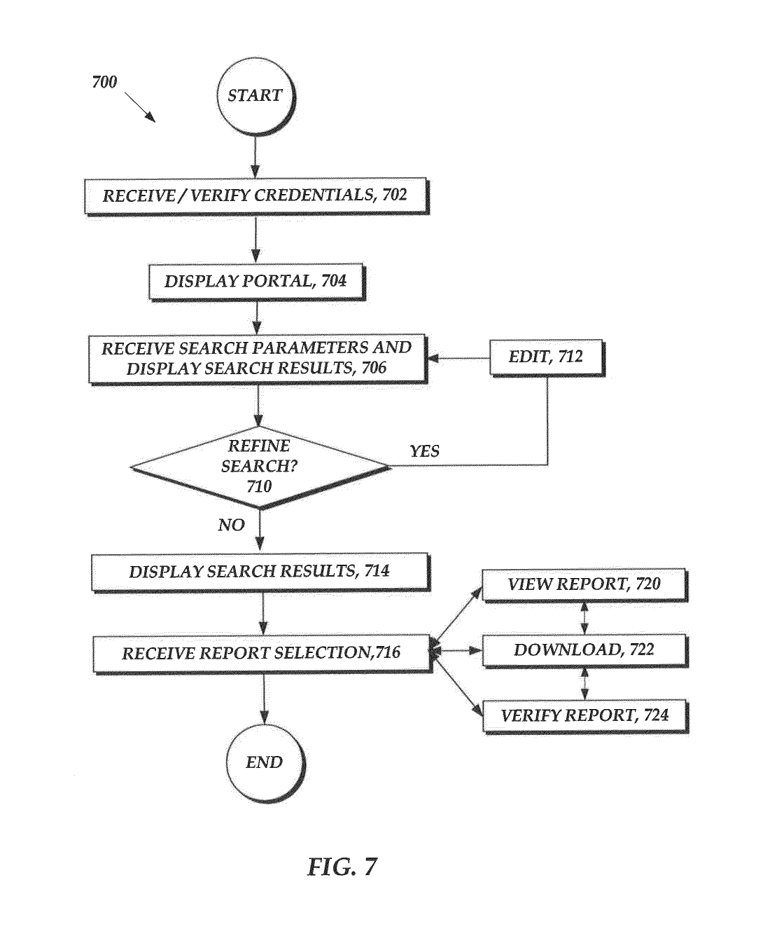

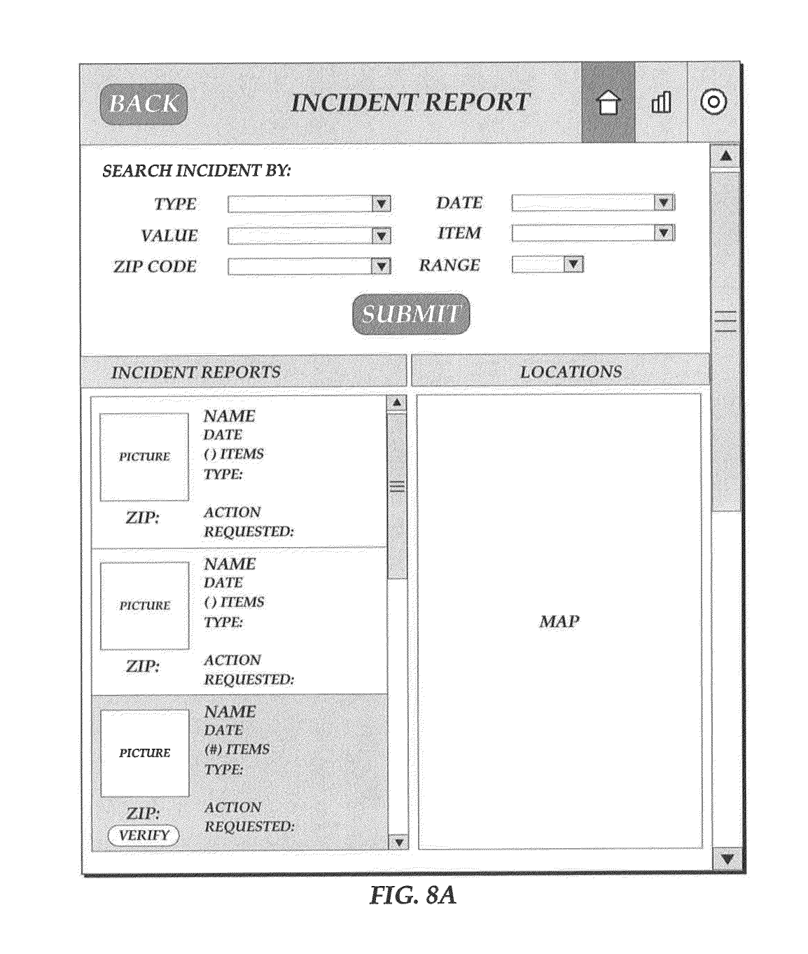

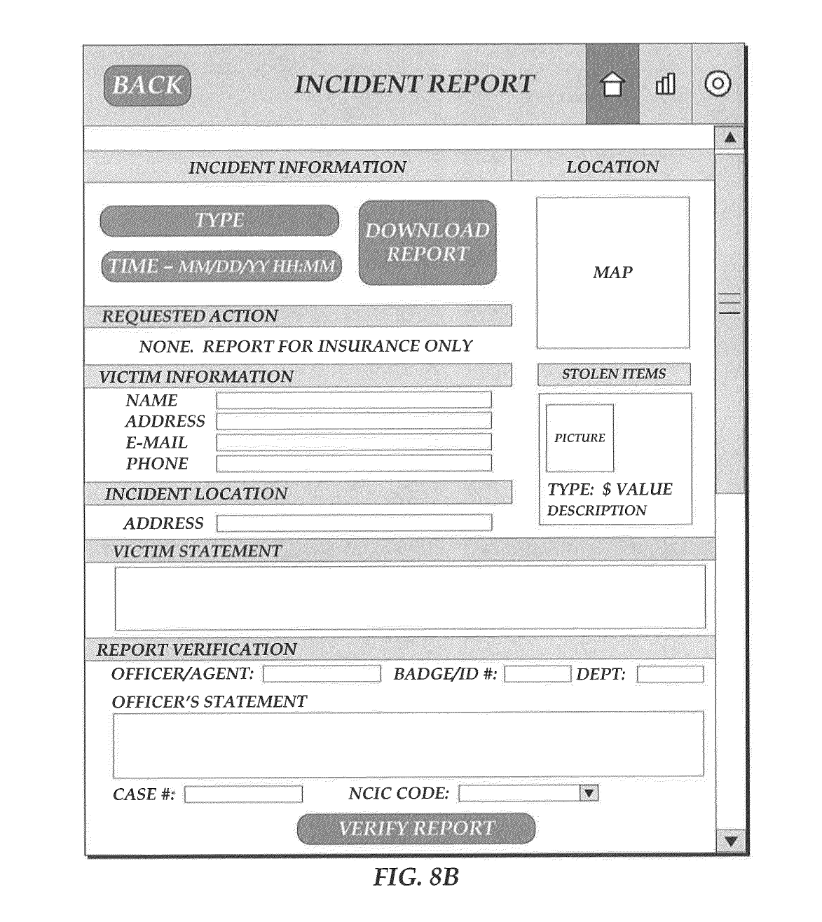

The discussion will now turn to the embodiments of FIGS. 7 and 8A-8B. FIG. 7 illustrates a flow diagram including process 700 performed by the system 102 for hosting the law enforcement portal. FIGS. 8A-8B illustrate embodiments of user interfaces corresponding to the process 700.

In operation 702, law enforcement personnel may present credentials (e.g., a username/password, and/or further credentialing information (e.g., keys, cookies, tokens, etc,) to gain access to the law enforcement portal. Upon verification of the law enforcement personnel, the process 700 moves to operation 704, Where a home page of the portal is displayed. As illustrated in FIG. 8A, law enforcement personnel may search for incident reports based upon one or more search criteria, including, but not limited to, an incident type, item value, an incident location (e.g., zip code), an incident date, an item type, a range from the input incident location.

In response to the receipt of the search request, the law enforcement portal 220 provides a set of search results to the law enforcement computing device 106. Should the search results require editing or refinement, the process 700 allows the search results to be edited in operation 712 and subsequently returns to operation 706. Alternatively, law enforcement personnel may view a displayed list of search results and make selections there from.

As illustrated in the user interface of FIG. 8B, the incident report displayed by the law enforcement portal 220 in operation 720 may include any portion or all of the information submitted to the system 102. The law enforcement personnel may further download one or more incident reports returned from the search in operation 722.

In operation 724, law enforcement personnel may verify a selected incident report. For example, the user interface displaying the incident report may further include a section allowing law enforcement personnel to input information verifying the incident report. The verification information may include, but is not limited to, an officer/agent name, a badge number, a department, an officer's statement, a law enforcement case number (alternatively, this may be auto-generated), an NCIC code, and the like. Additional verification information, as known in the art, may be further submitted, as necessary.

The submitted, verified incident report may be stored by the system 102 in order to facilitate replacement of insured stolen/lost items, For example, verified incident reports may be exposed to authorized users of the system 102 (e.g., insurance agents). Agents may employ his or her vendor computing device 108 to search, select, view, and download verified incident reports as discussed above with respect to the law enforcement portal 120 as part of an insurance claim process.

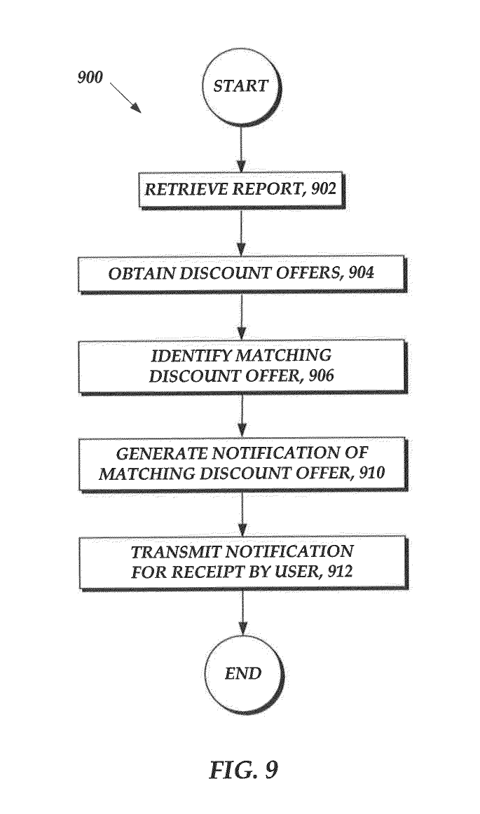

With further reference to FIG. 9, in alternative embodiments, the system 102 (e.g., property replacement component 122) may perform process 900 for identifying and transmitting an discount offer for purchase of the lost/stolen item. For example, in operation 902, the incident report (either as-submitted by the user or after verification by law enforcement personnel) including the user selected item descriptions of stolen/lost items, is obtained.

In operation 904, a plurality of discount offers are obtained. The discount offers include an offer for sale of respective items at a discounted price, as compared to a retail price In an embodiment, discount offers may be retrieved from the vendor computing device 108, stored in the data storage device 110, and periodically updated, as necessary. In operation 906, the items associated with the received discount offers are compared to the user selected item(s) listed in the incident report as stolen/lost. Any lost/stolen items matching an item associated with a received discount offer may be identified.

Subsequently, in operations 910-912, the user may be informed of the identified discount offer(s). In an embodiment, the identified discount offer(s) may be stored in the data store 110 for a selected period of time. In further embodiments, the system 102 may generate a notification for the user including the discount offer (e.g., a physical mailing, an electronic mail message, an electronic notification accessible to the user from the system 102, etc.). The notification is transmitted for receipt by the user in operation 912.

In further embodiments, upon redemption of a discount offer by the user, the system 102 may further receive a report of the same.

in additional operations, a user reporting a lost or stolen item may choose to have a portion of their incident report made available to the public to facilitate retrieval. For example, the user may select a public display option during preparation of the incident report or by editing the incident report after submission (e.g., operation 504, FIG. 6B). Upon submission of the incident report, a portion of the information contained therein may be displayed in a portal (e.g., website, mobile application, etc.) that is publically searchable and allows reporting of found items. For example, as illustrated in FIG. 10, a member of the public may search the portal by location (e.g., zip code, address, point of interest, etc,), time/date, type of item, etc. and any reported incidents have allowed to be made public are displayed.

The search results returned by the system 102 may provide information sufficient to allow the public to positively identify that a found item is likely a reported item. Examples of such information may include, but are not limited to, item pictures, descriptions, incident location information, etc. The returned results may be further filtered by one or more criteria. Examples include, but are not limited to, a product category and type of incident report (e.g., all reports, lost item reports, stolen item reports, found item reports, etc.). Upon finding an item, the public may select a user interface object (e.g., a “Found” button associated with an item) to report that an item has been found. In certain embodiments, the person reporting the found item may be further requested to provide contact information allowing the item owner to arrange for its retrieval.

The public portal may be further configured to protect the privacy of the owner. For example, publically displayed information regarding the owner may be limited in order to preserve their identity, location, or other personal information. For example, the owner's full name may be omitted and only a first name or alias displayed. In further examples, only a city or other geographical region (e.g., zip code, neighborhood, etc.) of the incident may be displayed, rather than the exact location. When an item is reported as being found, the system 102 may send a notification to the user using the user's account profile information (e.g., an e-mail address, telephone number, social media account, etc.). In this manner, the notification may be provided to the user without exposing their contact information. The user may subsequently contact the individual who has found the item to arrange for its retrieval.

Embodiments of the above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component, The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier interact protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla Firefox available from Mozilla Corporation). The mobile computing device includes, for example, a Blackberry®.

The terms comprise, include, and/or plural forms of each are open ended and include the listed parts and can include additional parts that are not listed, The term and/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method of facilitating replacement of a stolen item, comprising:
receiving a first user profile;
receiving a plurality of item descriptions associated with the first user profile;
storing the received item descriptions and the associated first user profile in a first plurality of computer-readable data structures;
receiving a selection constituting an item description selected from the plurality of item descriptions stored in the first plurality of computer-readable data structures;
receiving an item loss description describing loss of the selected item;
storing an item loss report in a second plurality of computer-readable data structures, the item loss report including the first user profile, the selected item descriptions, and the loss incident description;
obtaining a third plurality of computer-readable data structures including a discount offer authorizing purchase of the selected item from a vendor at a discount from a retail purchase price;
comparing the selected item description from the second plurality of data structures and the item discount offer from the third plurality of data structures;
identifying an item discount offer corresponding to the selected item description; and
generating a notification including the identified discount offer;
wherein the method is performed by one or more processors executing computer readable code embodied in non-transitory computer usable media.

2. The method of claim 1, further comprising transmitting the notification for receipt by a computing device of the user associated with the first user profile.

3. The method of claim 1, wherein the item description includes one or more of: a text description, plurality of photographs, a purchase receipt, and an item serial number.

4. The method of claim 1, wherein the loss report includes one or more of a loss time, loss location, perpetrator description, weapon description, and estimated item cost.

5. The method of claim 1, further comprising:
receiving a law enforcement profile, different than the first user profile;
transmitting the item loss report to a second user, different than the first user, associated with the law enforcement profile; and
receiving a transmission including a law enforcement validation of the item loss report.

6. The method of claim 5, wherein the law enforcement profile includes a credential uniquely identifying a law enforcement officer, a law enforcement agency, or a designate thereof.

7. The method of claim 5, further comprising:
receiving an insurance agent profile, different than the first user profile and the law enforcement profile;
receiving a request for at least a portion of the validated item loss report; and
transmitting the requested, validated item loss report to a third user, different than the first and second users, associated with the insurance agent profile.

8. The method of claim 1, further comprising receiving a transmission indicating redemption of the identified discount offer included in the notification.

9. A system for facilitating replacement of a stolen item, comprising:
a data storage device; and
one or more processors in communication with the data storage device, the one or more processors operative to:
receive a first user profile;
receive a plurality of item descriptions associated with the first user profile;
store the received item descriptions and the associated first user profile in a first plurality of computer-readable data structures;
receive a selection constituting an item description selected from the plurality of item descriptions stored in the first plurality of computer-readable data structures;
receive an item loss description describing loss of the selected item;
store an item loss report in a second plurality of computer-readable data structures, the item loss report including the first user profile, the selected item descriptions, and the loss incident description;
obtain a. third plurality of computer-readable data structures including a discount offer authorizing purchase of a item from a vendor at a discount from a retail purchase price;
compare the selected item description from the second plurality of data structures and the item discount offer from the third plurality of data structures;
identify an item discount offer corresponding to the selected item description; and
generate a notification including the identified discount offer.

10. The system of claim 9, Wherein the one or more processors are further adapted to transmit the notification for receipt by a computing device of the user associated with the first user profile.

11. The system of claim 9, wherein the one or more processors are further adapted to:
generate a first plurality of user interfaces for receiving the first user profile; and
generate a second plurality of user interfaces for receiving the item description selection and the item loss description.

12. The system of claim 9, wherein the item description includes one or more of: a text description, plurality of photographs, a purchase receipt, and an item serial number.

13. The system of claim 9, wherein the loss report includes one or more of a loss time, loss location, perpetrator description, weapon description, and estimated item cost.

14. The system of claim 9, wherein the one or more processors are further adapted to:
receive a law enforcement profile, different than the first user profile;
transmit the item loss report to a second user, different than the first user, associated with the law enforcement profile; and
receive a transmission including a validation of the requested item loss report.

15. The system of claim 14, wherein the law enforcement profile includes a credential uniquely identifying a law enforcement officer, a law enforcement agency, or a designate thereof.

16. The system of claim 14, wherein the one or more processors are further adapted to:
receive an insurance agent profile, different than the first user profile and the law enforcement profile;
receive a request for at least a portion of the validated item loss report; and
transmit the requested, validated item loss report to a third user, different than the first and second users, associated with the insurance agent profile.

17. The system of claim 16, wherein the one or more processors are further adapted receive a transmission indicating redemption of the identified discount offer included in the notification.

18. The system of claim 16, wherein the one or more processors are further adapted to:
generate a third plurality of user interfaces for receiving the law enforcement profile and item loss report request; and
generate a fourth plurality of user interfaces for receiving the insurance agent profile and requesting the validated item loss report.

19. The system of claim 9, wherein the one or more processors are further adapted to receive a transmission indicating redemption of the identified discount offer included in the notification.
